(19) United States
(12) Patent Application Publication
(10) Pub. No.: US 2013/0171034 A1
(43) Pub. Date: Jul. 4, 2013

(54) Flu Gas Detoxification System; Carbon Dioxide; Carbon Monoxide; Poisons; Twenty One Stage Reduction; Scrubber Recovery; Hydrochloric Acid HCl Chemical Suppressants; and Distillation Recovery.

(71) Applicant: Robert Richard Matthews, Washington, DC (US)

(72) Inventor: Robert Richard Matthews, Washington, DC (US)

(21) Appl. No.: 13/342,039

(22) Filed: Jan. 1, 2012

(51) Int. Cl. B01D 53/62

(52) U.S. Cl. 422/168

(57) ABSTRACT

Plant Flu Gas Detoxification System is scientifically designed and utilized as a twenty skid scrubber and common reservoir basin recovery distillation reduction to chemically control plant flu gas discharge to chemically change carbon monoxide CO, reduce carbon dioxide CO2, to a new yield of water H2O, carbon dioxide CO2, and calcium chloride CaCl2. No emissions are admitted into the atmosphere. One hundred percent 100% of the waste products are controlled as recycled chemical substances composition bottled carbon dioxide CO2, calcium chloride CaCl2 solids, or hazardous solid waste.

### BACKGROUND OF THE INVENTION

Over the past twenty years civilizations world-wide have learned about global warming greenhouse gas emissions specifically from power plant and industrial processing plant pollution that are injected into the atmosphere destroying the ozone layer. A few technologies have been developed to conquer the problem. However even today there isn't a comprehensive plan to manage plant flu gas waste to chemically control carbon dioxide CO2, carbon monoxide CO, and poisons from start to finish. This plant flu gas detoxification system utility patent application specification is scientifically designed and utilized as a comprehensive system to control one hundred percent 100% of plant flu gas emissions.

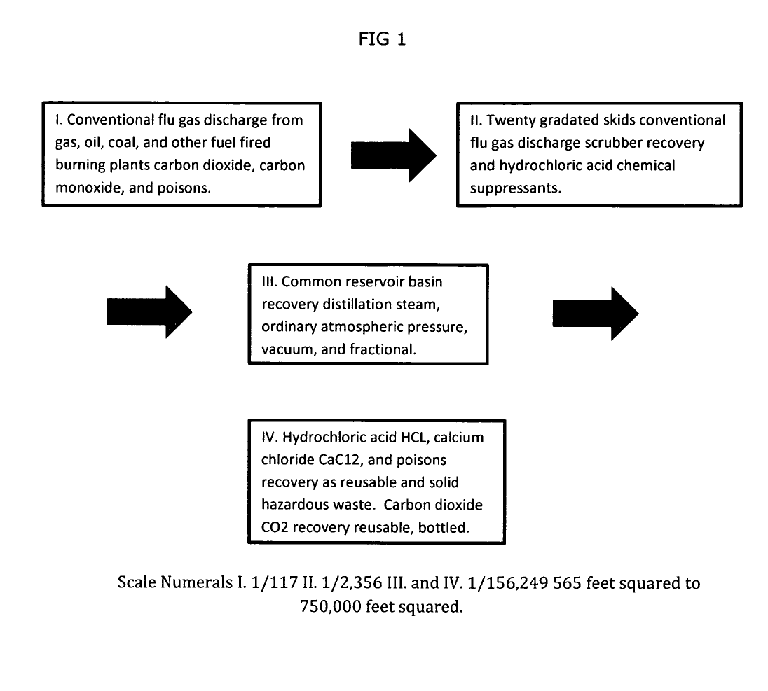

### Brief Description of FIG. 1 Block Diagram and Theorem of 21 Stage Reduction

Detailed Description of FIG. 1 Block Diagram and Theorem of 21 Stage Reduction numerals I. Flu gas discharge II. Twenty skid scrubber III. Common resivoir basin recovery distillation IV. Bottled Carbon Dioxide CO2, Recycled Materials, and Hazardous Waste.

### BRIEF SUMMARY OF THE INVENTION

This Plant Flu Gas Detoxification System is scientifically designed and utilized as a comprehensive plan to chemically control plant flu gas discharge to chemically change carbon monoxide CO, reduce carbon dioxide CO2, to a new yield of water H2O, carbon dioxide CO2, and calcium chloride CaCl2. No emissions are admitted into the atmosphere. One hundred percent 100% of the waste products are controlled as recycled materials bottled carbon dioxide CO2, calcium chloride CaCl2 solids, or hazardous solid waste.

### DETAILED DESCRIPTION OF THE INVENTION

Plant flu gas discharge enters the flu gas stack from a fuel fired furnace. A central processing unit CPU computer controls twenty gates that are gradated vertically at even intervals along the stack. Each gate is opened and closed at intervals as the central processing unit CPU computer monitors discharge from the fuel fired furnace from scientific distribution and measurement in cubic feet per millisecond of volume of flu gas discharge.

There are twenty 20 flu gas stack gates each attached and assigned to a specific cylindrical horizontal skid.

There are twenty 20 cylindrical horizontal skids that receive flu gas discharge recovery at intervals from each flu gas stack gate.

The flu gas discharge enters the cylindrical horizontal skid and receives a hydrochloric acid HCL suppressant.

The carbon monoxide CO absorbs and neutralizes the hydrochloric acid

HCL and yields water H2O and calcium chloride CaCl2.

There are twenty 20 hydrochloric acid HCL injection nozzles evenly spaced along each cylindrical horizontal skid.

Each cylindrical horizontal skid is channeled to a common reservoir basin recovery distillation process system.

The common reservoir basin recovery distillation process system from recovery to recycled and waste material utilizes four scientific principles of distillation operation that are steam, ordinary atmospheric pressure, vacuum, and fractional.

The four scientific principles of distillation steam, ordinary atmospheric pressure, vacuum, and fractional are utilized to reduce gas, oil, coal, and other fuel fired furnace power or industrial plant flu gas discharge to recyclable bottled carbon dioxide CO2, calcium chloride CaCl2 solids, water H2O, and hazardous solid waste.

The Plant Flu Gas Detoxification System is scientifically designed and utilized to convert carbon monoxide CO and hydrochloric acid HCL to yield recyclables calcium chloride CaCl2 solids and water H2O.

The Plant Flu Gas Detoxification System is scientifically designed and utilized to reduce carbon dioxide CO2 and poisons plant flu gas discharge to one hundred percent 100% emission free operation with recyclables bottled CO2 and hazardous solid waste.

1. The Plant Flu Gas Detoxification System is scientifically designed and utilized to convert carbon monoxide CO and hydrochloric acid HCL to yield recyclables calcium chloride CaCl2 solids and water H2O.

2. The Plant Flu Gas Detoxification System is scientifically designed and utilized to reduce carbon dioxide CO2 and poisons plant flu gas discharge to one hundred percent 100% emission free operation with recyclables bottled CO2 and hazardous solid waste.

3. The named inventor Robert R. Matthews reserves the right of this utility patent application specification to apply four scientific principles of distillation steam, ordinary atmospheric pressure, vacuum, and fractional to reduce gas, oil, coal, and other fuel fired furnace power or industrial plant flu gas discharge to recyclable bottled Carbon Dioxide CO2, calcium chloride CaCl2 solids, water H2O, and hazardous solid waste.
